(19) United States
(12) Patent Application Publication
(10) Pub. No.: US 2015/0231912 A1
(43) Pub. Date: Aug. 20, 2015

(54) MAGNETIC SECURITY ELEMENT HAVING THREE-DIMENSIONAL MOVING HIDDEN IMAGE EFFECT AND METHOD FOR PRINTING SAME

(71) Applicant: Korea Minting, Security Printing & ID Card Operating Corp., Daejeon (KR)

(72) Inventors: June Hee Yoon, Daejeon (KR); Dong Hoo Kim, Yeongi-gun (KR); Dong Jei Cho, Daegu (KR)

(21) Appl. No.: 14/428,625

(22) PCT Filed: Sep. 16, 2013
(86) PCT No.: PCT/KR2013/008323

§ 371 Date: Mar. 16, 2015

(30) Foreign Application Priority Data
Sep. 14, 2012 (KR) 10-2012-0102110

(51) Int. Cl. B42D 25/30; B42D 25/41

(52) U.S. Cl. CPC B42D 25/30; B42D 25/41

(57) ABSTRACT

The present invention relates to a magnetic security element showing a three-dimensional (3D) moving hidden image effect and a method of printing the same, which comprises the steps of: printing a predetermined line pattern on the surface of a substrate using a magnetic ink; applying a magnetic field to the pattern-formed substrate; and drying and curing the substrate to which the magnetic field was applied. According to the present invention, a hidden image can be formed, which cannot be realized by copying and reversibly appears and disappears. Thus, the magnetic security element can be used to prevent forgery or alteration.

### TECHNICAL FIELD

The present invention relates to a magnetic security element showing a three-dimensional (3D) moving hidden image effect and a method of printing the same, and more particularly to a magnetic security element showing a 3D moving hidden image effect, which is produced by printing a predetermined pattern on a substrate using magnetic ink, applying a magnetic field to the pattern-printed substrate by magnets having various shapes to form magnetically induced images, and drying and curing the substrate having the magnetically induced image formed thereon, and to a method of producing the magnetic security element.

### BACKGROUND ART

Various cards such as cash cards or credit cards, various certificates such as passports, policies or driver licenses, checks, securities, paper money, brand products, industrial product materials that are imparted with information such as fabrication history, food labels that are imparted with information with production places or production dates, etc., can be forged or altered. Security features for identifying forgery and preventing forgery by copying include sophisticated guilloche patterns, intricate screen traps, complex drawings composed of lines having different thicknesses, and various special security features. With the development of printing techniques, many studies on the development of special functional materials and the production of specialty inks from the functional materials have been conducted, and the development of a technology for adding security features to printed images is also increasing.

As this technology for preventing the counterfeit of articles, various types of optically variable devices have been used. Among them, optically variable ink (OVI) that changes color depending on viewing angle is particularly important, and is used to print the surface and witness that show a viewing angle-dependent color.

In recent years, in order to maximize such optically variable effects, printing inks or magnetic optically variable inks that allow magnetically induced images, designs and patterns to be produced in a coating by the application of a magnetic field have been used. Such magnetic optically variable inks allow a coating to be dried and cured after the orientation of magnetic optically variable pigment particles in the coating, so that magnetically induced images, designs or patterns are recognized to have a three-dimensional or relief-type appearance, even though the images, designs or patterns are still in a geometrically flat state.

Korean Patent Laid-Open Publication No. 10-2009-0068249 discloses a device or method of magnetically transferring indicia, such as a design or an image, to a wet coating layer comprising magnetic or magnetizable particles, applied to a sheet or a substrate. However, a magnetically induced design produced by the method merely shows an optically variable effect, and the patent publication does not disclose that a magnetically induced image, design or pattern shows reversible appearance and disappearance effects by tilting or rotation together with 3D mobility by a change in the intensity of a magnetic field.

Accordingly, the present inventors have made extensive efforts to solve the above-described problems, and as a result, have found that a magnetic security element showing a 3D moving hidden image effect can be produced by printing a predetermined pattern comprising magnetic ink-printed regions alternating with non-printed regions, applying a magnetic field to the pattern-printed substrate by magnets having various shapes to form a magnetically induced image, and drying and curing the substrate having the magnetically induced image formed thereon, thereby completing the present invention.

### SUMMARY

It is an object of the present invention to provide a magnetic security element showing a 3D moving hidden image effect, which is produced by printing a predetermined pattern on a substrate using a magnetic ink, applying a magnetic field to the pattern-printed substrate by magnets having various shapes to form a desired image, and drying and curing the substrate having the image formed thereon, and a method of producing the magnetic security element.

To achieve the above object, the present invention provides a magnetic security element having a 3D moving hidden image effect, comprises: a substrate having an alternating pattern of a printed region and non-printed region of a magnetic ink on surface of the substrate, wherein in case that a magnetic field is applied to the pattern-printed substrate by a magnet, a magnetically induced image is formed, thereby showing a 3D moving hidden image effect.

The present invention also provides a method of producing a magnetic security element having a 3D moving hidden image effect, comprising the steps of: (a) printing an alternating pattern of a printed region and non-printed region on a surface of a substrate using magnetic ink; (b) applying a magnetic field to the pattern-printed substrate by a magnet to form a magnetically induced image; and (c) drying and curing the substrate having the magnetically induced image formed thereon.

### BRIEF DESCRIPTION OF THE DRAWINGS

FIG. 1 shows examples of various features and patterns printable by silk screen printing, and the thickness of printed lines.

FIGS. 2a and 2b are cross-sectional views showing lines 1 printed on an opaque substrate 2 or a transparent substrate 3 by screen printing.

FIG. 2c is a partially enlarged view of FIG. 2a, which shows printed distance (pd) and non-printed distance (npd), and FIG. 2d is a cross-sectional view showing a non-oriented, magnetic optically variable ink printed material before the application of a magnetic field thereto.

FIG. 3 shows that a magnetic field is applied to a printed material by magnets 4 having various intensities and shapes, immediately after screen printing, but before curing.

FIG. 4 shows the various shapes of an Nd magnet 5, a ferrite magnet 6 and a rubber magnet 7, which are used to apply a magnetic field to a wet, screen-printed material before curing to form a magnetically induced image.

FIG. 5 shows that a magnetic field is applied to a wet, screen-printed material by a donut-shaped Nd, spaced from a certain distance from the printed material, in order to form a donut-shaped, magnetically induced image.

FIG. 6a is a top plan view showing a printed material having a donut-shaped, magnetically induced image formed thereon, and FIG. 6b is an enlarged view of the image portion of FIG. 6a, which shows the orientation of magnetizable optically variable pigment particles.

FIGS. 7a and 7b are top plan views showing that the color of an optically variable pigment is changed from magenta to gold by a change in viewing angle or the position of a light source while a 3D pattern portion applied with a magnetic field appears like it moves (d and d′) from the original position (solid dotted line).

FIG. 8 shows a hidden image effect in which a 3D image applied with a magnetic field reversibly appears and disappears as a printed material is tilted in a certain direction.

FIG. 9 shows a 3D moving hidden image effect that appears in various security features.

*Explanation on Symbols*

| | |
|---|---|
| 1: magnetic ink | 2: opaque substrate |
| 3: transparent substrate | 4: magnet |
| 5: Nd magnet | 6: ferrite magnet |
| 7: rubber magnet | |

### DETAILED DESCRIPTION OF EMBODIMENTS

Unless defined otherwise, all technical and scientific terms used herein have the same meaning as commonly understood by one of ordinary skill in the art to which the invention pertains. Generally, the nomenclature used herein and the experiment methods are those well known and commonly employed in the art.

In the present invention, a 3D moving hidden image is realized by the printing of a specific pattern, the use of magnets having various shapes, and the control of intensity of a magnetic field, and the effect thereof can be identified by tilting and rotation. As used herein, the term “3D moving” means the dynamic effect of the image, and the term “hidden image” means an image that appears depending on viewing angle, and is a security feature for preventing forgery, which cannot be realized by copying.

In one aspect, the present invention is directed to a magnetic security element having a 3D moving hidden image effect, comprises: a substrate having an alternating pattern of a printed region and non-printed region of a magnetic ink on surface of the substrate, wherein in case that a magnetic field is applied to the pattern-printed substrate by a magnet, a magnetically induced image is formed, thereby showing a 3D moving hidden image effect.

In another aspect, the present invention is directed to a method of producing a magnetic security element having a 3D moving hidden image effect, comprising the steps of: (a) printing an alternating pattern of a printed region and non-printed region on a surface of a substrate using magnetic ink; (b) applying a magnetic field to the pattern-printed substrate by a magnet to form a magnetically induced image; and (c) drying and curing the substrate having the magnetically induced image formed thereon.

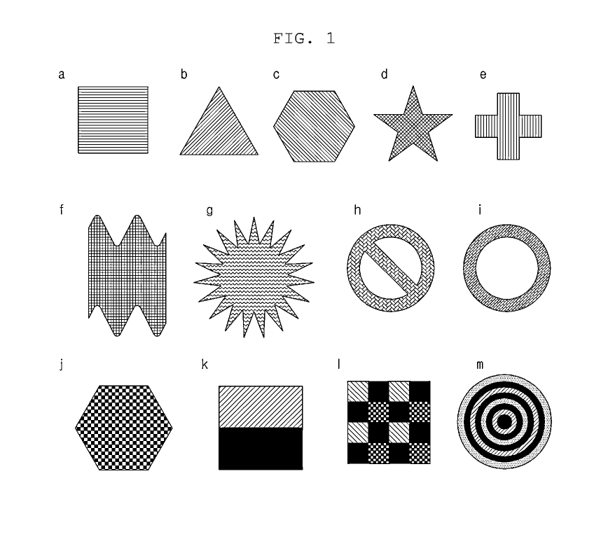

As shown in FIG. 1, the pattern comprising printed regions alternating with non-printed regions may be a line pattern such as a line pattern a, b, c or e or a crossed-solid line pattern d or f, a point pattern such as a dot pattern j, or a design pattern such as a wave pattern g or a brick pattern i. In addition, the pattern may be a composite pattern k, l or m comprising at least one of the above patterns and a completely printed region, but is not limited thereto, any pattern may be used in the present invention, as long as it results in a 3D moving hidden image effect which is formed as magnetic pigment particles are oriented in response to an applied magnetic field.

In the pattern, a printed distance (pd) may be larger than a non-printed distance (npd).

In the present invention, a silk screen printing technique was used to print the pattern, but is not limited thereto, and other methods capable of applying ink may also be used. Specifically, gravure printing, lithographic printing, flexographic printing, letterpress printing, intaglio printing, or conventional methods known to apply ink may be used, in which ink can be applied to different regions to form lines having different thicknesses or colors. The mesh size of a silk screen for forming a designed solid line pattern may be 150-250 meshes, but is preferably 150 meshes, because an increase in the number of meshes leads to an increase in the thickness of ink.

In the present invention, the ratio of the non-printed distance (npd) to the printed distance (pd) in the line pattern may be 0.25-1.25. In the present invention, in order to examine the 3D moving hidden image effect of a printed pattern, an experiment was performed using a printed distance of 1-2 mm while changing the non-printed distance to 0.25 mm, 0.5 mm, 0.75 mm, 1.25 mm, 1.5 mm and 1.75 mm. As a result, it was shown that the 3D moving hidden image effect was better as the printed distance was larger and the non-printed distance was smaller, and that when the printed distance was larger than the non-printed distance, the 3D moving hidden image effect appeared, and when the printed distance was smaller than the non-printed distance, the effect did not appear or was insignificant (see Tables 1 to 3). Particularly, it was shown that when the ratio of the non-printed distance (npd) to the printed distance (pd) was 0.25-1.25, the 3D moving hidden image effect was good, and when the ratio was 0.5-0.75, the 3D moving hidden image effect was better.

In addition, the effect of the ratio of lightness background (Lb) to lightness print (Lp), (Lb/Lp), was examined. As a result, it was shown that the 3D moving effect was regardless of lightness. However, in order to realize a hidden image, the ratio of lightness background (Lb) to lightness print (Lp) may be 1.2-100, preferably 60-100, and more preferably 80-100. When the ratio of lightness background (Lb) to lightness print (Lp) is less than 1.2, the hidden image effect does not appear.

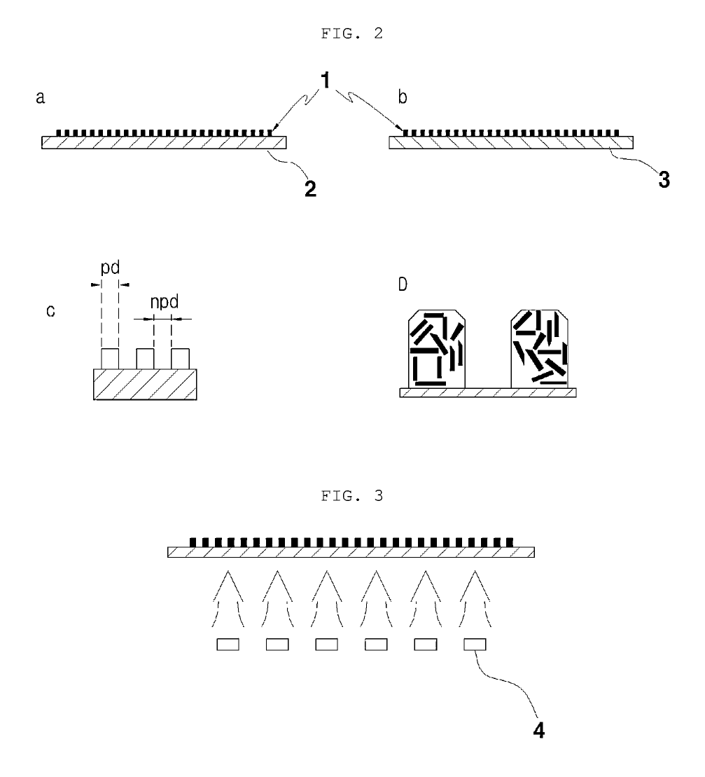

In the present invention, a substrate having a thickness of 50-150 μm is used as a base on which a magnetic ink is to be printed. As shown in FIG. 2a, the substrate may be an opaque substrate 2 such as paper, a foil or polypropylene (PP), or a transparent film substrate 3 such as polyvinyl chloride (PVC), polycarbonate (PC) or polyethylene terephthalate (PET).

A magnetic ink (1 in FIG. 2) that is used for screen printing may be either UV curable ink or solvent-evaporating ink. As a flake pigment that can be aligned upon the application of a magnetic field, a color-changing pigment that changes color depending on the position of an observer or the position of a light source. A method of preparing a magnetic ink is as follows.

The UV curable ink may be prepared by mixing 30-35 wt % of an oligomer, 35-40 wt % of a monomer, 3-5 wt % of a photopolymerization initiator, and 10-20 wt % of a magnetic pigment and stirring the mixture, but is not limited thereto. The oligomer may be a urethane-based acrylic resin, and the monomer may be a low-viscosity monomer consisting of a mixture of pentaerythritol hexaacrylate and pentaerythritol triacrylate. In addition, the photopolymerization initiator may be Micure MS-7 (MOWONSC) comprising 2-methyl-1-[4-(methylthio)phenyl]-2-(4-morpholinyl)-1-propanone.

The solvent-evaporating ink may be prepared by mixing 25-30 wt % of thermoplastic resin, 30-40 wt % of a solvent, 5-10 wt % of a drying retarder, and 10-20 wt % of a magnetic pigment, but is not limited thereto. The thermoplastic resin may be a copolymer of polyvinyl alcohol with polyvinyl acetate, and the solvent may be a mixture of cyclohexane and ethylbenzene.

In the case of the solvent-evaporating ink among the two kinds of inks, the separation of some of the components occurs during curing, and for this reason, the selection of hot-air intensity and drying time (1-2 minutes), which influence the orientation of a magnetic pigment that is aligned by magnetic patterning, is particularly important. Thus, in order to obtain a screen-printed material having a highly reproducible, magnetically induced image, UV curable ink is preferably used.

A magnet is used to apply a magnetic field to the wet, screen-printed material after screen printing, but curing. The magnet is characterized by a uniaxial magnetization direction, and may be an NdFeB magnet, an SmCo magnet, a ferrite magnet, a ferrite magnet, an Alnico magnet, a Fe—Cr—Co magnet, an Sm—Fe—N magnet or an electromagnet. However, an NdFeB magnet or a ferrite magnet is more preferable in terms of availability, durability and strength.

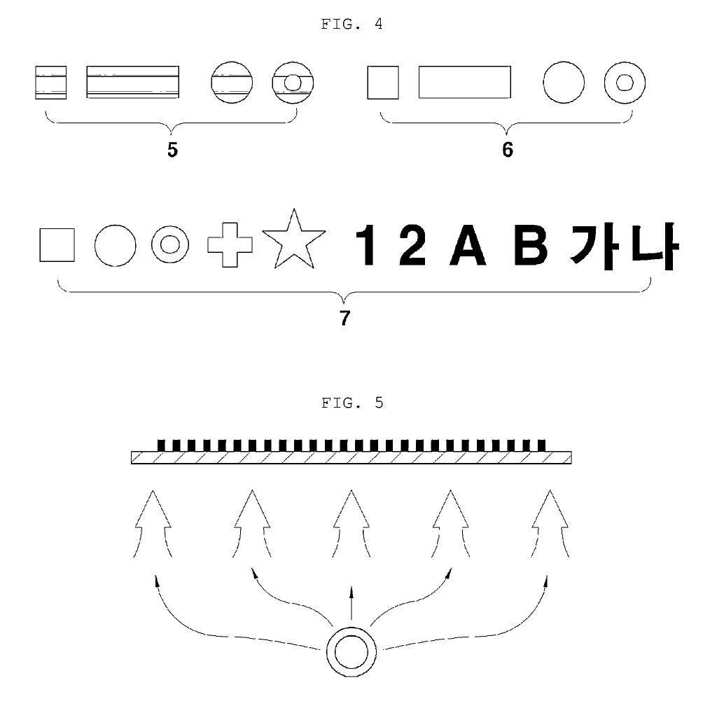

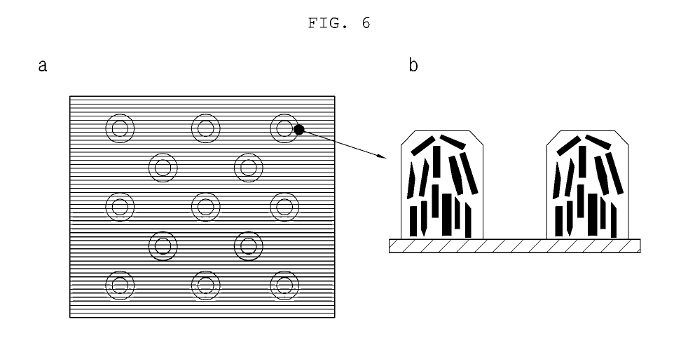

FIG. 4 shows the various shapes of a magnet that is used to apply a magnetic field to a wet, printed material before curing. As shown therein, magnetically induced images can be formed using magnets having various shapes, including a square shape, a circular shape, a donut shape, a cross shape, a star shape, a letter shape and the like, but are not limited thereto. According to the present invention, it is possible to produce a magnetic security element that shows various hidden images depending on interactions between a specific printed pattern and magnetically induced images (FIG. 9).

FIG. 6a is a top plan view showing UV-cured 3D pattern images caused by the directional patterning of optically variable pigment particles oriented by applying a magnetic field to a wet, screen-printed material before curing as shown in FIG. 5. To apply a magnetic field of about 0.5 Tesla to a magnetic pigment having a mass magnetic susceptibility of 10⁻³ to 10⁻⁶ m³/kg, the distance of a magnet from the wet, screen-printed material is controlled in the range of 1.5-5 mm. If the distance of the magnet from the material is less than 1.5 mm, the intensity of the magnetic field will be strong so that overlapping images can be formed, and if the distance is more than 5 mm, the intensity of the magnetic field will be weak so that the magnetic pigment contained in the ink cannot be oriented according to magnetic field lines.

When UV curable ink is used to maintain the orientation of pigment particles oriented in the direction of magnetic field lines, a 3D moving hidden image is realized by the orientation of the magnetic pigment particles after drying the ink by UV irradiation, and when solvent-evaporating ink is used, a 3D moving hidden image is realized by the orientation of the magnetic pigment particles after naturally drying the ink by solvent evaporation, followed by curing.

In order to examine the 3D moving effect of the present invention, a cured substrate with donut-shaped magnetically induced images were tilted in a certain direction (upward and downward).

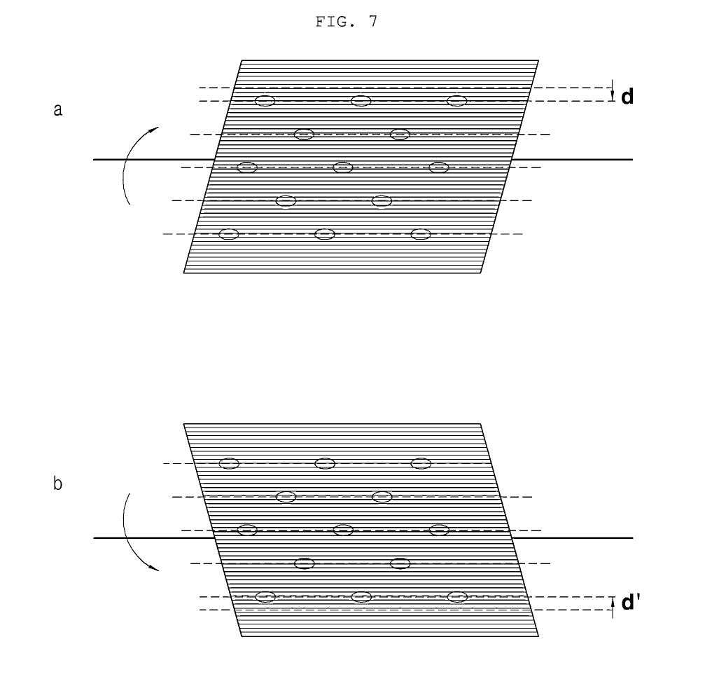

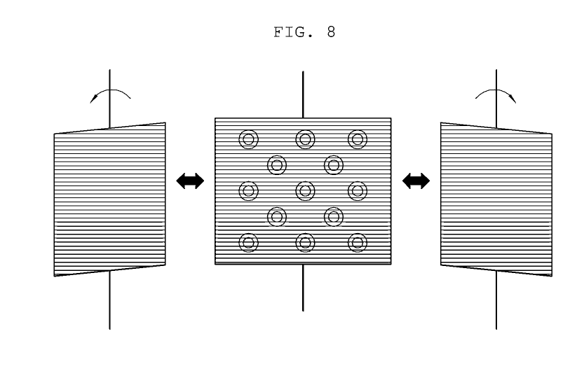

FIGS. 7a and 7b schematically show color and mobility, which change upon tilting. As shown therein, when a printed material is tilted upward (FIG. 7a), the color of the printed material changes from magenta to gold while the position of the pattern appears like it moves (d in FIG. 7a) in a direction (downward) opposite to the tilting direction (upward). In addition, when the printed material is tilted downward (FIG. 7b), the color of the printed material changes from magenta to gold while the position of the pattern appears like it moves (d′ in FIG. 7b) in a direction (upward) opposite to the tilting direction (downward). Although not shown in the figure, this effect is the same in all directions on the x-y plane. In other words, when the printed material is returned to the original position, the color and the position of the image appear like they return to the original state. Thus, the magnetic security element of the present invention is characterized by showing a reversible dynamic effect.

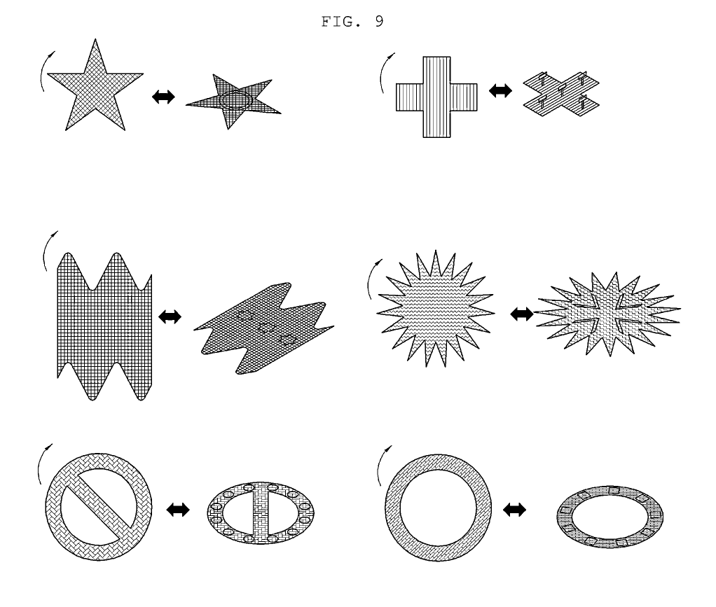

In addition, as shown in FIG. 8, the donut-shaped hidden image that is realized according to the present invention has an optical illusion effect in that the hidden image appears or does not appear when the line-printed material is tilted or rotated.

Thus, the magnetic security element according to the present invention, which shows the 3D moving hidden image effect, can be used as a security element for preventing the forgery or alteration of paper money, securities, identification cards, cash or credit cards, bills, etc., and provides 3D dynamic effects that can be visually identified. In addition, images in prior security features for preventing forgery were transferred by copying, whereas the 3D moving hidden image according to the present invention is visible only under a specific condition, and cannot be transferred using current printers, scanners and duplicators.

### EXAMPLES

Hereinafter, the present invention will be described in further detail with reference to examples. It will be obvious to a person having ordinary skill in the art that these examples are illustrative purposes only and are not to be construed to limit or change the scope of the present invention.

### Example 1

### Preparation of UV Curable Magnetic Ink

36 wt % of an oligomer, 40 wt % of a monomer, 4 wt % of a photopolymerization initiator and 20 wt % of a magnetic pigment were mixed and stirred to prepare a UV curable ink. As the monomer, a low-viscosity monomer consisting of a mixture of pentaerythritol hexaacrylate and pentaerythritol triacrylate was used. As the photopolymerization initiator, 2-methyl-1-[4-(methylthio)phenyl]-2-(4-morpholinyl)-1-propanone was used, and as the optically variable pigment, Colorcrypt M (Merck) was used.

### Experimental Example 1

### Effects of Printed Distance and Non-Printed Distance

Using the UV curable ink prepared in Example 1, solid line patterns as shown in FIG. 1a were printed on PET films by a screen printing method. Herein, the number of screen meshes was 150, and the printed distance and the non-printed distance were controlled as shown in Table 1 below. A magnetic field was applied to the films using an NdFeB magnet having a remanent magnetic flux density of 11.7-12.1 KG and a coercive force of 12 KOe or more in a state in which the distance between the magnet and the film was controlled to 3 mm. Then, the films were dried and cured. As a result, it could be seen that the 3D moving hidden image effect was better as the printed distance was larger and the non-printed distance was smaller (Table 1). Particularly, it could be seen that, when the ratio of the non-printed distance to the printed distance was 0.25-1.25, a more distinct 3D moving hidden image effect could be obtained.

TABLE 1

| non-printed | | | | | |
|---|---|---|---|---|---|
| distance | printed distance (pd) (mm) | | | | |
| (npd) (mm) | 0.25 | 0.5 | 1 | 1.5 | 2 |
| 1.75 | X | Δ | Δ | ◯ | ◯ |
| 1.5 | X | Δ | Δ | ◯ | ◯ |
| 1.25 | X | X | ◯ | ◯ | ◯ |
| 0.75 | X | Δ | ◯ | ◯ | ◯ |
| 0.5 | X | Δ | ◯ | ◯ | ◯ |
| 0.25 | Δ | Δ | ◯ | ◯ | ◯ |

◯: the 3D moving hidden image effect appeared.
Δ: the effect indistinctly appeared.
X: the effect did not appear.

### Experimental Example 2

### Effect of the Distance Between Substrate and Magnet

The distance between the magnet and the substrate was controlled to 5 mm while the same experimental conditions were used. As a result, it was shown that, as the distance of the magnet from the substrate decreased, the orientation of the magnetic pigment particles was improved, and thus the 3D moving hidden image effect was better (Table 2).

TABLE 2

| non-printed | | | | | |
|---|---|---|---|---|---|
| distance | printed distance (pd) (mm) | | | | |
| (npd) (mm) | 0.25 | 0.5 | 1 | 1.5 | 2 |
| 1.75 | X | X | Δ | Δ | ◯ |
| 1.5 | X | X | Δ | Δ | ◯ |
| 1.25 | X | X | Δ | ◯ | ◯ |
| 0.75 | X | Δ | Δ | ◯ | ◯ |
| 0.5 | X | Δ | Δ | ◯ | ◯ |
| 0.25 | X | Δ | Δ | ◯ | ◯ |

◯: the 3D moving hidden image effect appeared.
Δ: the effect indistinctly appeared.
X: the effect did not appear.

### Experimental Example 3

### Effect of Screen Mesh Number

In order to examine the effect of the screen mesh number, an experiment was performed using 200 screen meshes under the same conditions (the distance between the magnet and the substrate: 3 mm) as shown in Table 1. As a result, it was shown that, as the number of meshes increased, the amount of ink decreased, and thus the 3D moving hidden image effect was reduced compared to when 150 screen meshes were used (Table 3).

TABLE 3

| non-printed | | | | | |
|---|---|---|---|---|---|
| distance | printed distance (pd) (mm) | | | | |
| (npd) (mm) | 0.25 | 0.5 | 1 | 1.5 | 2 |
| 1.75 | X | X | Δ | Δ | ◯ |
| 1.5 | X | Δ | Δ | ◯ | ◯ |
| 1.25 | X | X | Δ | ◯ | ◯ |
| 0.75 | X | Δ | ◯ | ◯ | ◯ |
| 0.5 | X | Δ | ◯ | ◯ | ◯ |
| 0.25 | Δ | Δ | ◯ | ◯ | ◯ |

◯: the 3D moving hidden image effect appeared.
Δ: the effect indistinctly appeared.
X: the effect did not appear.

### Example 2

### 3D Moving Hidden Image Effect of Donut-Shaped Images

Using the UV curable magnetic ink prepared in Example 1, a solid line pattern as shown in FIG. 6 was printed on a PET film by a screen printing method. Herein, the following conditions were used: printed distance (pd)=1.5 mm; non-printed distance (npd)=0.75 mm; pd≧pd; and npd/pd=0.5. In addition, the ratio of lightness background to lightness print was 1.2 or more, and a silk screen having 150 meshes was used.

After printing, donut-shaped magnetically induced images were formed by applying a magnetic field to the wet printed material using an NdFeB magnet in a state in which the distance between the substrate and the magnet was controlled to 1.5 mm. After the magnetic pigment particles were oriented, the printed material was dried and cured using a UV curing device in order to maintain the particles in the oriented state, thereby obtaining a magnetic security element having 3D moving hidden images (FIG. 8).

### INDUSTRIAL APPLICABILITY

As described above, the magnetic security element according to the present invention, which shows a 3D moving hidden image effect, can be produced by various printing methods, and can be applied to various cards such as cash cards or credit cards, various certificates such as passports, policies or driver licenses, checks or securities, which can be forged or altered. In addition, it offers a 3D moving hidden image effect, which can be visually identified by tilting or rotation and cannot be realized by copying. Thus, it is particularly useful for the prevention of counterfeit.

Although the present invention has been described in detail with reference to the specific features, it will be apparent to those skilled in the art that this description is only for an embodiment and does not limit the scope of the present invention. Thus, the substantial scope of the present invention will be defined by the appended claims and equivalents thereof.

1. A magnetic security element having a 3D moving hidden image effect, comprising:
a substrate having an alternating pattern of a printed region and a non-printed region of a magnetic ink on surface of the substrate,
wherein in case that a magnetic field is applied to the pattern-printed substrate by a magnet, a magnetically induced image is formed, thereby showing a 3D moving hidden image effect.

2. The magnetic security element of claim 1, wherein the alternating pattern of a printed region and non-printed region is at least one selected from the group consisting of a line pattern, a point pattern, and a design pattern.

3. The magnetic security element of claim 2, wherein the alternating pattern of a printed region and non-printed region is at least one selected from the group consisting of a solid line pattern, a crossed-solid line pattern, a dot pattern, a wave pattern, and a brick pattern.

4. The magnetic security element of claim 1, wherein the alternating pattern of a printed region and non-printed region is formed in combination with a completely printed region.

5. The magnetic security element of claim 1, wherein the pattern is a pattern in which a printed distance (pd) is larger than a non-printed distance (npd).

6. The magnetic security element of claim 2, wherein a ratio of a non-printed distance (npd) to a printed distance (pd) in the line pattern is 0.25-1.25.

7. The magnetic security element of claim 1, wherein the substrate is selected from the group consisting of paper, a foil, polypropylene (PP), polyvinyl chloride (PVC), polycarbonate (PC), and polyethylene terephthalate (PET).

8. The magnetic security element of claim 1, wherein the ratio of lightness background (Lb) to lightness print (Lp) is 1.2-100.

9. The magnetic security element of claim 1, wherein the magnet is selected from the group consisting of an NdFeB magnet, an SmCo magnet, a ferrite magnet, an Alnico magnet, an Fe—Cr—Co magnet, an Sm—Fe—N magnet, and an electromagnet.

10. The magnetic security element of claim 1, wherein the distance between the substrate and the magnet is 1.5-5 mm.

11. The magnetic security element of claim 1, wherein the magnetic ink is UV curable ink or solvent-evaporating ink.

12. The magnetic security element of claim 11, wherein the UV curable ink is prepared by mixing and stirring 30-35 wt % of an oligomer, 35-40 wt % of a monomer, 3-5 wt % of a photopolymerization initiator and 10-20 wt % of a magnetic pigment.

13. The magnetic security element of claim 11, wherein the solvent-evaporating ink is prepared by mixing and stirring 25-30 wt % of thermoplastic resin, 30-40 wt % of a solvent, 5-10 wt % of a drying retarder, and 10-20 wt % of a magnetic pigment.

14. The magnetic security element of claim 1, wherein the pattern is printed by using a screen printing technique, a gravure printing technique, a lithographic printing technique, a flexographic printing technique, a letterpress printing technique, or an intaglio printing technique.

15. A method of producing a magnetic security element having a 3D moving hidden image effect, comprising the steps of:
(a) printing an alternating pattern of a printed region and non-printed region on a surface of a substrate using magnetic ink;
(b) applying a magnetic field to the pattern-printed substrate by a magnet to form a magnetically induced image; and
(c) drying and curing the substrate having the magnetically induced image formed thereon.

16. The method of claim 15, wherein in step (a), the alternating pattern of a printed region and non-printed region is at least one selected from the group consisting of a line pattern, a point pattern, and a design pattern.

17. The method of claim 15, wherein the alternating pattern of a printed region and non-printed region is formed in combination with a completely printed region.

18. The method of claim 15, wherein a printed distance (pd) is larger than a non-printed distance (npd).

19. The method of claim 16, wherein a ratio of a non-printed distance (npd) to a printed distance (pd) in the line pattern is 0.25-1.25.

20. The method of claim 15, wherein a ratio of lightness background (Lb) to lightness print (Lp) is 1.2-100.

21. The method of claim 15, wherein in step (b), the magnet is selected from the group consisting of an NdFeB magnet, an SmCo magnet, a ferrite magnet, an Alnico magnet, an Fe—Cr—Co magnet, an Sm—Fe—N magnet, and an electromagnet.

22. The method of claim 15, wherein in step (b), a distance between the substrate and the magnet is 1.5-5 mm.

23. The method of claim 15, which in step (c), the drying of the substrate is performed by a UV curing process or a solvent-evaporating process.
